(19) United States
(12) Patent Application Publication
(10) Pub. No.: US 2006/0002256 A1
(43) Pub. Date: Jan. 5, 2006

(54) Network-based information recording/reproducing system and information recording/reproducing apparatus

(75) Inventor: Hiroyuki Kamio, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/132,225

(22) Filed: May 19, 2005

(30) Foreign Application Priority Data
Jun. 30, 2004 (JP) 2004-195020

(51) Int. Cl. G11B 15/52; G11B 5/09

(52) U.S. Cl. 369/47.1; 369/59.1

(57) ABSTRACT

Disclosed is a network-based information recording/reproducing system including: a first information recording/reproducing apparatus that transmits a session start request to a second information recording/reproducing apparatus connected thereto via a router or network, receives a session establishment notice in response thereto, transmits an information content to the second apparatus, receives a content receipt completion notice from the second apparatus, and transmits an release instruction to release other session reject mode; and the second information recording/reproducing apparatus that receives the session start request and transmits the session establishment notice to the first apparatus and at the same time establishes the other session reject mode rejecting a session start request from a third information recording/reproducing apparatus when receiving the session start request from the first apparatus, and transmits the content receipt completion notice to the first apparatus when completed to receive the information content transmitted by the first apparatus.

### CROSS-REFERENCE TO THE INVENTION

This application is based upon and claims the benefit of priority from the prior Japanese Patent Application No.2004-195020, filed on Jun. 30, 2004; the entire contents of which are incorporated herein by reference.

### BACKGROUND

1. Field of the Invention

The present invention relates to a network-based information recording/reproducing system and an information recording/reproducing apparatus, and particularly to a network-based information recording/reproducing system and an information recording/reproducing apparatus that dub a video content via a network.

2. Description of the Related Art

In recent years, a variety of video recording/reproducing apparatuses including a DVD (Digital Versatile Disk) player/recorder are widely used in the world around us including households.

In particular, DVDs exhibiting high information storing capabilities have been researched and developed for higher density and speed, producing certain results. In the meantime, on the back of the unification of standards in an aim for a global standard, the development of the apparatuses have been making progress and realized further usable and unified apparatuses.

Further, among the DVD players/recorders, for example, a technology for equipping a hard disk drive and a DVD drive together and recording a video and audio recorded in the hard disk into the DVD has been developed, serving to users in view of usability.

However, the video recording function of the conventional video recording/reproducing apparatuses such as the DVD player/recorder is limited to that transmits/receives the video and audio information within the same apparatus.

In this connection, there are movements seeking for a technology to transmit/receive contents via the network, and, for example, there is a document describing a data structure to transmit/receive contents via the network.

However, even though there are the movements seeking for the technology to transmit/receive contents via the network and in which for example the document describing the data structure to transmit/receive contents via the network is provided, they assumes only two units of apparatus, namely a transmitter apparatus and receiver apparatus, in the network so far, not assuming and considering about a third apparatus, other than the transmitter and receiver apparatuses, which performs another content transmission/reception request to the apparatuses already in a content transmission transaction.

### SUMMARY

The present invention has been made to bring a solution to the above described problem, and an object thereof is to provide a network-based information recording/reproducing system and an information recording/reproducing apparatus capable of dubbing a video content among a plurality of apparatuses via a network by way of an exclusive control even when a third apparatus except a transmitter apparatus and a receiver apparatus in the network interrupts and requests another content transmission/reception in the course of a content transmission/reception between the transmitter and receiver apparatuses.

In detail, an object of the present invention is to provide a network-based information recording/reproducing system and an information recording/reproducing apparatus capable of controlling interruptions exclusively even when a third apparatus except a transmitter apparatus and a receiver apparatus in the network interrupts and requests another content transmission/reception in the course of a content transmission/reception between the transmitter and receiver apparatuses.

In more detail, an object of the present invention is to provide a network-based information recording/reproducing system and an information recording/reproducing apparatus capable of preventing such an inconvenience of transmission processing even when the network has a plurality of information recording/reproducing apparatuses, that leads to an insufficient capacity error in a content transmission between a first transmitter apparatus and a first receiver apparatus due to a second transmitter apparatus which interrupts in the midstream of the above content transmission between the first transmitter and receiver apparatuses by requesting a content transmission and eventually performs the content transmission to the first receiver apparatus first so that the disk capacity of the first receiver apparatus ever intended for the transmission by the first transmitter apparatus ends up to be consumed.

An information recording/reproducing system according to the present invention is a network-based information recording/reproducing system having a plurality of information recording/reproducing apparatuses connected via a network/router to transmit/receive information including video among the information recording/reproducing apparatuses, each of the information recording/reproducing apparatuses is provided with at least a processing unit, a first and/or second information medium device(s), and a communication control unit, including: a first information recording/reproducing apparatus being a transmitter or requester of the information that transmits a session start request to a second information recording/reproducing apparatus connected thereto via the router/network, receives a session establishment notice being a return to the session start request, transmits an information content to the second information recording/reproducing apparatus, receives a content receipt completion notice from the second information recording/reproducing apparatus, and transmits an instruction to release an other session reject mode to the second information recording/reproducing apparatus; and a second information recording/reproducing apparatus that notices a session establishment to the first information recording/reproducing apparatus in response to the session start request received and at a same time establishes the other session reject mode rejecting the session start request from a third information recording/reproducing apparatus, and transmits the content receipt completion notice to the first information recording/reproducing apparatus when the information content transmitted by the first information recording/reproducing apparatus is completely received.

According to the present invention configured in the above described manner, when a video recording/reproducing apparatus having a content recorded in an internal record medium thereof transmits the content to the other video recording/reproducing apparatus via a network, with a mode change of the receiver apparatus by the transmitter apparatus to a mode rejecting every content transmission request from the other apparatuses, it is possible to prevent an inconvenience of transmission processing possibly caused in the network having the plurality of apparatuses connected thereto, in which the content transmission between the first transmitter and receiver apparatuses is interrupted by the second transmitter apparatus requesting and performing the content transmission therefrom so that the disk capacity of the first receiver apparatus ever intended for the transmission by the first transmitter apparatus is consumed by the transmission by the second transmitter apparatus, causing the insufficient capacity error.

An information recording/reproducing apparatus according to the present invention is an information recording/reproducing apparatus provided with at least a central processing unit, a first and/or second information medium device(s), and a communication control unit, in which the central processing unit includes an information transfer response means for transmitting via the communication control unit a session start request for an information content transmission to opposite information recording/reproducing apparatus(es) connected thereto via a router/network, returning a session establishment notice to an opposite information recording/reproducing apparatus in response to the session start request received, and transmitting a transfer completion notice to the opposite information recording/reproducing apparatus when an information transfer is completed; a control means for establishing another session reject mode when receiving the session start request, the other session reject mode rejecting session start request(s) from other information recording/reproducing apparatus (es) than the information recording/reproducing apparatus being a requester of the session start request once received, the control means being also capable of releasing the other session reject mode; a content transmission means for transmitting an information content to a destination information recording/reproducing apparatus specified by information contained in the session start request; a record means for recording the transmitted information content onto a first or second information medium; and a reject mode release instruction means for transmitting an instruction signal to release the other session reject mode to an opposite apparatus when receiving the transfer completion notice notifying of a completion of an information content transfer.

According to the present invention configured in the above described manner, when a video recording/reproducing apparatus having a content recorded in an internal record medium thereof transmits the content to the other video recording/reproducing apparatus via a network, with a mode change to the receiver apparatus by the transmitter apparatus to a mode rejecting every content transmission request from the other apparatuses, it is possible to realize an information recording/reproducing apparatus capable of preventing an inconvenience of transmission processing possibly caused in the network having the plurality of apparatuses connected thereto, in which the content transmission between the first transmitter and receiver apparatuses is interrupted by the second transmitter apparatus requesting and performing a content transmission there from so that the disk capacity of the first receiver apparatus ever intended for the transmission by the first transmitter apparatus is consumed by the transmission by the second transmitter apparatus to thereby cause the insufficient capacity error.

In the above cases, the “information” of the “information content” includes video, audio, and data, as a concept. The “information recording/reproducing apparatus” means those apparatuses equipped with a certain drive for a record media and having an information recording and reproducing function, including, for example, a video recording/reproducing apparatus having a video recording/reproducing function onto/from a DVD.

Further, in the central processing unit related to the above-described information recording/reproducing apparatus, the “information transfer response means”, “control means”, “information content transmission means”, “record means”, and “reject mode release instruction means” are realizable by a circuit, logic design, software, chip or record medium mounting the software thereon, or the like realizing the corresponding above-mentioned functions.

According to the present invention, it is possible to provide a network-based information recording/reproducing system and an information recording/reproducing apparatus capable of dubbing a video content among a plurality of information recording/reproducing apparatuses via a network, even when a third apparatus existing in the network but neither a transmitter nor a receiver interrupts and requests a content transmission/receipt to the apparatus in the course of communication and transmission, by controlling to exclude such an interrupt of the third apparatus.

### BRIEF DESCRIPTION OF THE DRAWINGS

FIG. 1A and FIG. 1B are block diagrams respectively showing an overall configuration of a network-based information recording/reproducing system according to an embodiment of the present invention.

FIG. 2 is a block diagram showing a further detail functional configuration of a main unit 101 shown in FIG. 1A.

FIG. 3 is a block diagram showing a further detail functional configuration of a MPU 1014 according to an embodiment of the present invention shown in FIG. 2.

FIG. 4 is a timing chart related to a content transmission in the case where two units of the information recording/reproducing apparatuses according to the embodiment of the present invention are connected via a router or network.

FIG. 5 is a block diagram showing an overall configuration of a network-based information recording/reproducing system configured to include three units of the information recording/reproducing apparatuses according to the embodiment of the present invention, which are connected via the router or network.

FIG. 6 is a timing chart related to a content transmission in the case where three units of general information recording/reproducing apparatuses are connected via the router or network.

FIG. 7 is a timing chart related to a content transmission in the case where three units of the information recording/reproducing apparatuses according to the embodiment of the present invention are connected via the router or network.

FIG. 8 is a timing chart related to a content transmission in the case of a pull-type transmission and where three units of the information recording/reproducing apparatuses according to the embodiment of the present invention are connected via the router or network.

FIG. 9 is a timing and flow chart showing an operation of a video recording/reproducing apparatus according to another embodiment of the present invention.

### DETAILED DESCRIPTION

### Description of the Embodiments

The embodiments according to the present invention will be described with reference to the drawings, however, the drawings are provided for the purpose only of illustration and in no case limit the present invention.

According to a network-based information recording/reproducing system as a form of an embodiment of the present invention, a second information recording/reproducing apparatus may be configured to have a timeout that releases an other session reject mode established when no communication is detected for a predetermined time period. With this configuration, even when a communication error occurs, such an event that allows no other transmission due to the other session reject mode being kept effective as an example, can be prevented.

Further, as a form of an embodiment, the second information recording/reproducing apparatus may be configured to use a flag (busy flag or other session reject mode flag, this is also applicable hereinafter in the same manner except otherwise specifically mentioned therein) to establish and release the other session reject mode. With this configuration, the establishment and release of the other session reject mode can be realized surely and easily.

Further, as a form of an embodiment, the second information recording/reproducing apparatus may be configured to make an inquiry at predetermined intervals to the router about a new IP address that the second information recording/reproducing apparatus should have in a next time period when the other session reject mode is established, to receive the new IP address when it is returned in response to the inquiry, and to continuously have a previous IP address as the IP address of itself during the other session reject mode is established, even when the new IP address is different from the previous IP address. With this configuration, even when a router changing the IP address with time exists in the information recording/reproducing system, a transfer operation can be continued to the end of the session once established without being discontinued in the middle thereof due to the unexpected IP address change.

Still further, in the information recording/reproducing apparatus as a form of an embodiment of the present invention, a control means may be configured to have a timeout function releasing the other session reject mode established when no communication is detected for a predetermined time period. With this configuration, an event allowing no transmission from the other apparatus on the back of the other session reject mode kept effective due to for example a communication error occurred, can be prevented.

Still further, as a form of an embodiment according to the present invention, the control means may be configured to use a flag to establish and release the other session reject mode. With this configuration, the information recording/reproducing apparatus capable of establishing and releasing the other session reject mode surely and easily can be provided.

Still further, as a form of an embodiment, the control means may be configured to include a means for making an inquiry to the router at predetermined intervals about the new IP address that the information recording/reproducing apparatus itself should have in the next time period, and a means for continuously having the previous IP address as the IP address of itself during the other session reject mode is established, even when the new IP address returned by the router in response to the inquiry is different from the previous IP address. With this configuration, even when the information recording/reproducing apparatus is connected to the router changing the IP address with time, the transfer operation can be continued to the end of the session once established without being discontinued in the middle thereof due to the unexpected IP address change.

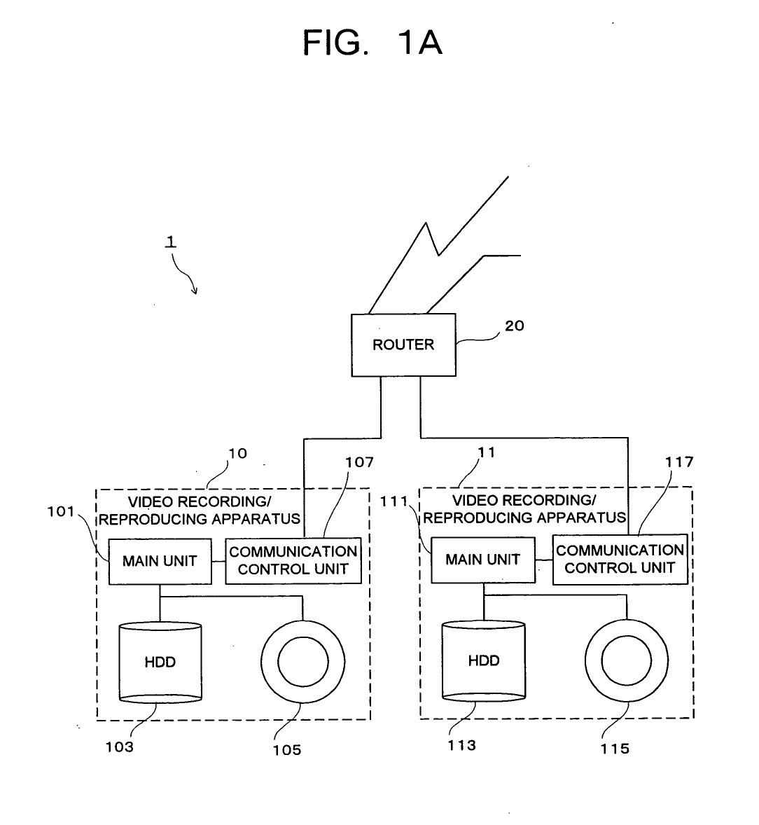

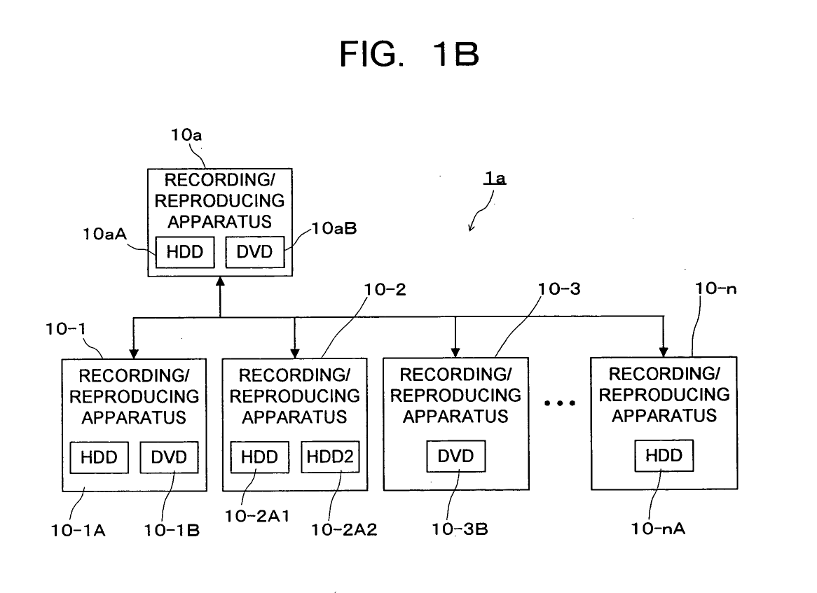

Based on the above, hereinafter, embodiments according to the present invention will be described with reference to the drawings. FIG. 1A is a block diagram showing an overall configuration of the network-based information recording/reproducing system according to an embodiment of the present invention. Note that, hereinafter, a scope required to attain the object as the embodiment is schematically shown and the description will be mainly given of the required scope, so that those omitted to describe shall be enabled by publicly known arts.

As shown in the drawing, a network-based information recording/reproducing system 1 according to an embodiment of the present invention is configured by connecting a video recording/reproducing apparatus 10 and a video recording/reproducing apparatus 11, which have a (later-described) configuration specific to the present embodiment, via for example a router 20 connected to a network. Hereinafter, the respective components will be described by citing the case of the video recording/reproducing apparatus 10 as an example. As shown in FIG. 1A, the video recording/reproducing apparatus 10 according to the embodiment of the present invention is composed of at least a main unit 101, a HDD (hard disk drive) 103 and a DVD drive 105 (which may be “DVD-RAM device” and the same is also applicable hereinbelow) that are connected to the main unit 101 via a bus, and a communication control unit 107 connected to the main unit 101. Similarly, the video recording/reproducing apparatus 11 is composed of at least a main unit 111, a HDD 113 and a DVD drive 115 that are connected to the main unit 111 via a bus, and a communication control unit 117 connected to the main unit 111.

Note that, for the purpose of mainly describing the relation between the video recording/reproducing apparatus 10 and the video recording/reproducing apparatus 11, the network-based information recording/reproducing system is assumed to have two units of video recording/reproducing apparatuses as components here, however, the number of the components of such a system is not limited to two or any number, and the spirit of the present embodiment is applicable to the case where any natural number “n” units of such components are connected as shown, for example, in FIG. 1B.

More specifically, in the case shown in FIG. 1B, an network-based information recording/reproducing system 1a according to the present embodiment is composed of a video recording/reproducing apparatus 10a, a video recording/reproducing apparatus 10-1, a video recording/reproducing apparatus 10-2, a video recording/reproducing apparatus 10-3, . . . , and a video recording/reproducing apparatus 10-n that are connected to each other via a network. The video recording/reproducing apparatus 10a includes a HDD 10aA and a DVD drive 10a B, the video recording/reproducing apparatus 10-1 includes a HDD 10-1A and a DVD drive 10-1B, the video recording/reproducing apparatus 10-2 includes a HDD 10-2A1 and a HDD 10-2A2, the video recording/reproducing apparatus 10-3 includes a DVD drive 10-3B, . . . , and the video recording/reproducing apparatus 10-n includes a HDD 10-nA. Thus, in the present embodiment, any video recording/reproducing apparatus is acceptable as long as it is provided with both the HDD (hard disk drive) and the DVD drive (the unit number is any number equals to one or more), or any one of the two types of drives (the unit number is any number equals to one or more), as a recording medium drive

Back to FIG. 1A, the main unit 101 controls entire operation of the system, and executes an operating system stored in a (not-shown) system memory and a target application program and so forth. The HDD drive 103 has function(s), based on an instruction from the main unit 101, to reproduce information written in a (not-shown) hard disk and/or to write information acquired via the communication control unit 107 into the hard disk.

The DVD drive 105 has function(s), based on an instruction from the main unit 101, to reproduce information written in a (not-shown) DVD and/or to write information acquired via the communication control unit 107 into the DVD. The communication control unit 107 transmits/receives information to/from the other apparatus (the video recording/reproducing apparatus 11, here) connected via the network, the communication control unit 107 being provided with an Ethernet (registered trademark) terminal.

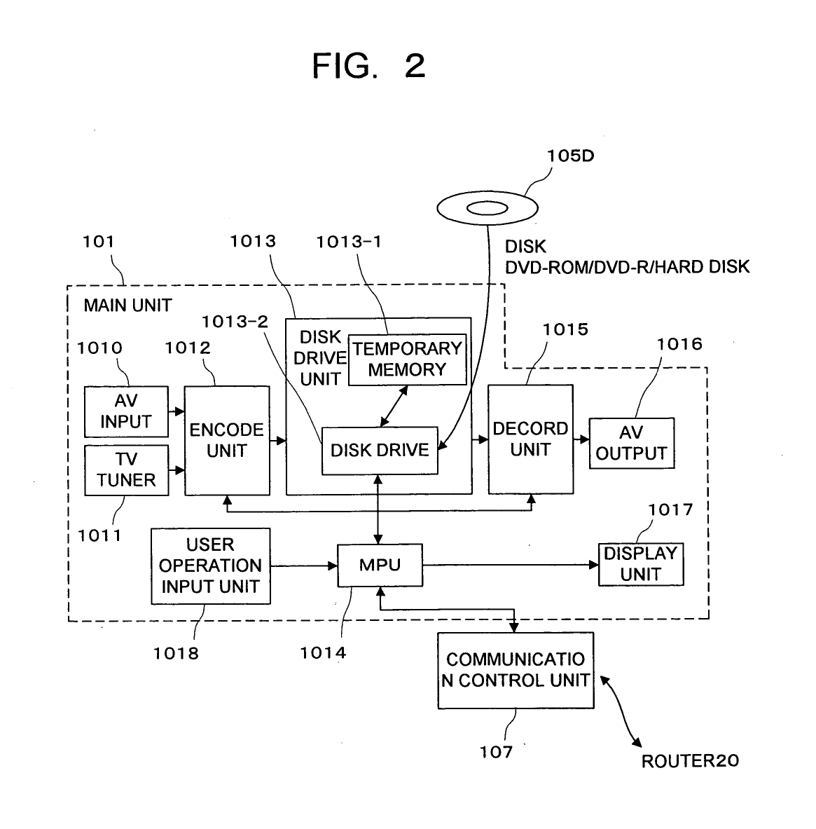

Subsequently, a further detailed description will be given of the configuration of the main unit 101 specific to the present embodiment. FIG. 2 is a block diagram showing a further detailed functional configuration of the main unit 101 shown in FIG. 1A. As shown in the drawing, the main unit 101 is composed of: an AV input 1010 to input information from outside; a TV tuner 1011; an encode unit 1012 composing a recording side; a disk drive unit 1013 reading/writing from/into a DVD-RAM, DVD-RW, DVD-R, or a HDD; a decode unit 1015 composing a reproducing side; an AV output 1016 outputting a reproduced information; an MPU (micro processing unit) 1014 controlling the operation of the apparatus itself; and a display unit 1017 to make a notice to a user.

As shown in FIG. 2, the disk drive unit 1013 is configured to include a disk drive 1013-2 and a temporary memory 1013-1. The temporary memory 1013-1 is used to buffer a prescribed amount of data out of the data written into a disk 105D via the disk drive 1013-2, or a prescribed amount of data out of the data reproduced by the disk drive 1013-2. Specifically, the temporary memory 1013-1 can be used to temporarily record the information to be recorded during the replacement of the disk 105D with a new one when the disk 105D is filled in the course of a recording operation.

The MPU (micro processing unit) 1014 executes: a control of a record onto the disk 105D, an operation change of the recording/reproducing apparatus depending on the input in a user operation input unit 1018, a display for the user with the display unit 1017, and so forth, in accordance with a control program.

Further, the MPU 1014 is connected with a communication control unit 107 receiving information from outside via the network or acquiring information from an outside apparatus.

The user operation input unit 1018 executes an operation request from the user, for example, the operation change of the recording/reproducing apparatus, a receipt of the video-recording reservation information, and so forth, and composed of, for example, a remote controller and a receiving unit for data from the remote controller.

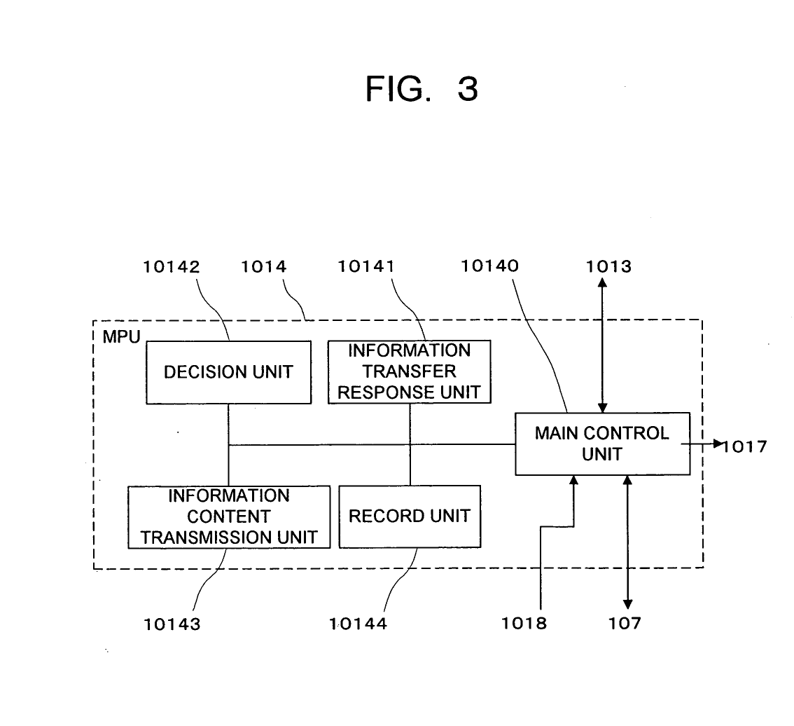

Subsequently, a further detailed description will be given of the configuration of the MPU 1014 specific to the present embodiment. FIG. 3 is a block diagram showing a further detailed functional configuration of the MPU 1014 shown in FIG. 2.

As shown in the drawing, the MPU 1014 is composed of, at least, a main control unit 10140, an information transfer response unit 10141, a decision unit 10142, an information content transmission unit 10143, and a record unit 10144. These respective units 10140 to 10144 are realized as a logical design of a circuit or a software (code) that realizes respective applicable functions described below, or otherwise realized by a chip, a record medium or the like mounting the software thereon.

The main control unit 10140 has functions to perform an overall control, to output a message required for a screen (which will be described later), and to accept an information input by a user; and is provided with a flag establishment section having a function to make a later-described busy flag ON, and a busy-mode release instruction section issuing a command to release a busy mode (other session reject mode) to the others when a content transmission is completed.

The information transfer response unit 10141 has functions to generate a session start request information for a (later-described) information content transmission to the information recording/reproducing apparatus (es) connected thereto via the router or network, to transmit the information to the router or network via the communication control unit 107, and to return a session start notice information in response to the session start request from the other apparatus.

The decision unit 10142 has functions to verify the session start request information received via the communication control unit 107 (from the other apparatus), to verify whether or not a (later-described) transmission is possible, to determine to reject, for example, the session start request from a third apparatus made when the apparatus is in a busy state, and to determine a destination apparatus (11, here) based on an IP address information contained in the session start request information.

The information content transmission unit 10143 has a function to transmit an information content using, for example, an Ethernet (registered trademark) to the destination recording/reproducing apparatus 11 specified by the IP address information and so on contained in the session start request information.

The record unit 10144 has a function to record the information content transmitted from the other video recording/reproducing apparatus (for example, from the recording/reproducing apparatus 11) onto an information storage device such as DVD, hard disk, or the like, when the video recording/reproducing apparatus 10 is a receiver of the information content.

Subsequently, detail operations of the video recording/reproducing apparatus 10 configured in the above-described manner will be described together with the detail operations of the network-based information recording/reproducing system 1 configured by connecting a plurality of such video recording/reproducing apparatuses via the network.

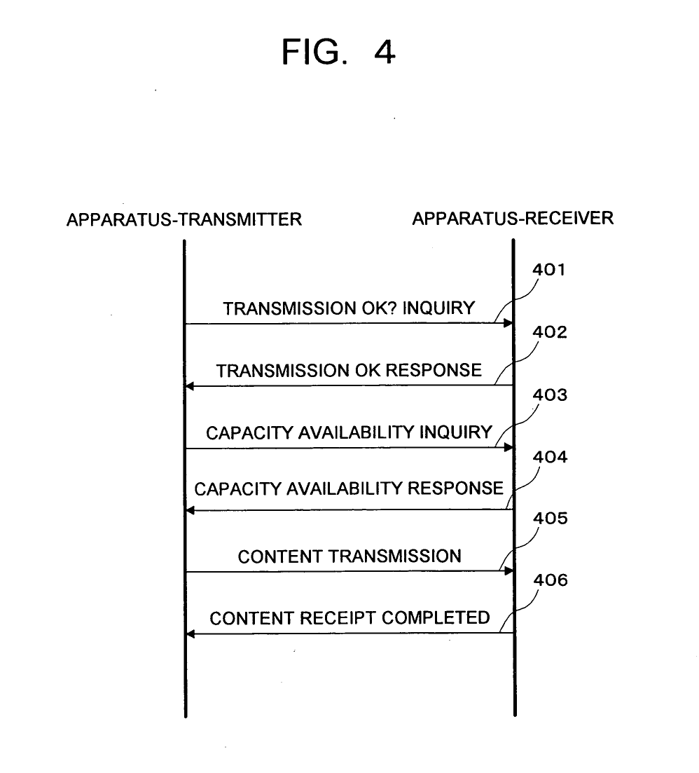

First, a mechanism to transfer a content from the recording/reproducing apparatus 10 to the recording/reproducing apparatus 11 using the Ethernet (registered trademark) will be considered. In the present embodiment, first, a push-type transmission will be considered. The push-type transmission is a transmission method of a type in which an apparatus having the content transmits the content data to an opposite party. In the case of this push-type transmission, the communication between a transmitter apparatus and a receiver apparatus is performed by the procedures shown in FIG. 4.

Specifically, first, the transmitter apparatus makes an inquiry to the receiver apparatus about whether a content transmission is acceptable/unacceptable (Step 401). The receiver apparatus returns an acceptable response to the transmitter apparatus (Step 402), and the transmitter apparatus makes an inquiry about the available capacity of the receiver (Step 403). The receiver returns a response as to the available capacity (Step 404) and when the content to be transmitted is of less than the available capacity, the content transmission is started (Step 405). When the entire content transmission is completed, a content receipt completion notice is transmitted from the receiver to the transmitter (Step 406).

Here, a case where three units or more of present apparatuses exist in the same network will be considered. Here, a description will be given on the assumption that the information recording/reproducing apparatuses connected via the router or network are three units or more.

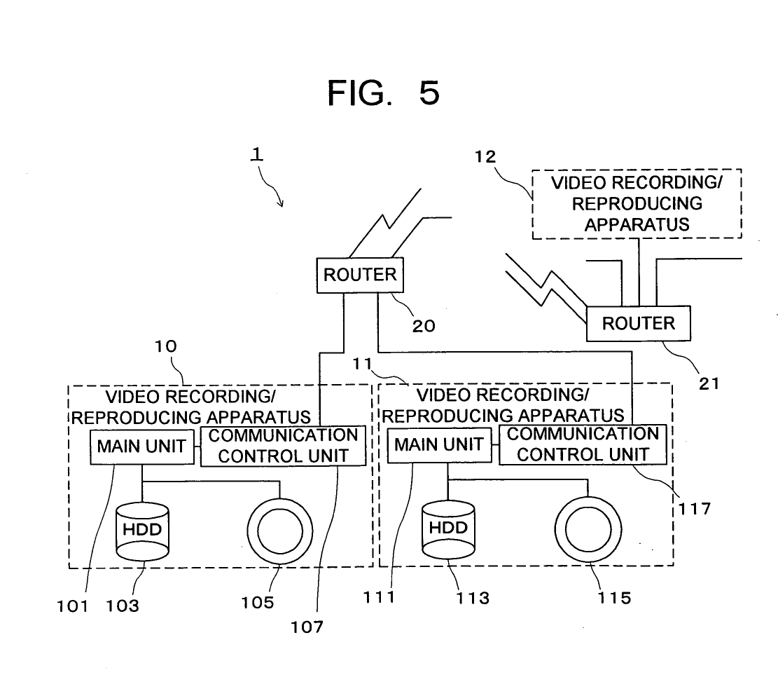

FIG. 5 is a block diagram showing a schematic configuration of the network-based information recording/reproducing system 1 configured by connecting via the router or network three units of information recording/reproducing apparatuses according to the embodiment of the present invention. The drawing is configured to include an information recording/reproducing apparatus 12 connected via another router 21 in addition to the configuration in FIG. 1. Note that, here, the three units are assumed as the number of the information recording/reproducing apparatuses more than two units, as an example, however, the number of the information recording/reproducing apparatuses is not limited to three and any number is applicable in the technical spirit of the present embodiment. The information recording/reproducing apparatuses 10, 11, 12 shown in FIG. 5 are assumed to have a configuration described with reference to FIGS. 1A, 2, and 3.

Hereinafter, a comparative description will be attempted in an effort to make the spirit according to the present embodiment be easily understandable. First, operations in a general case will be described.

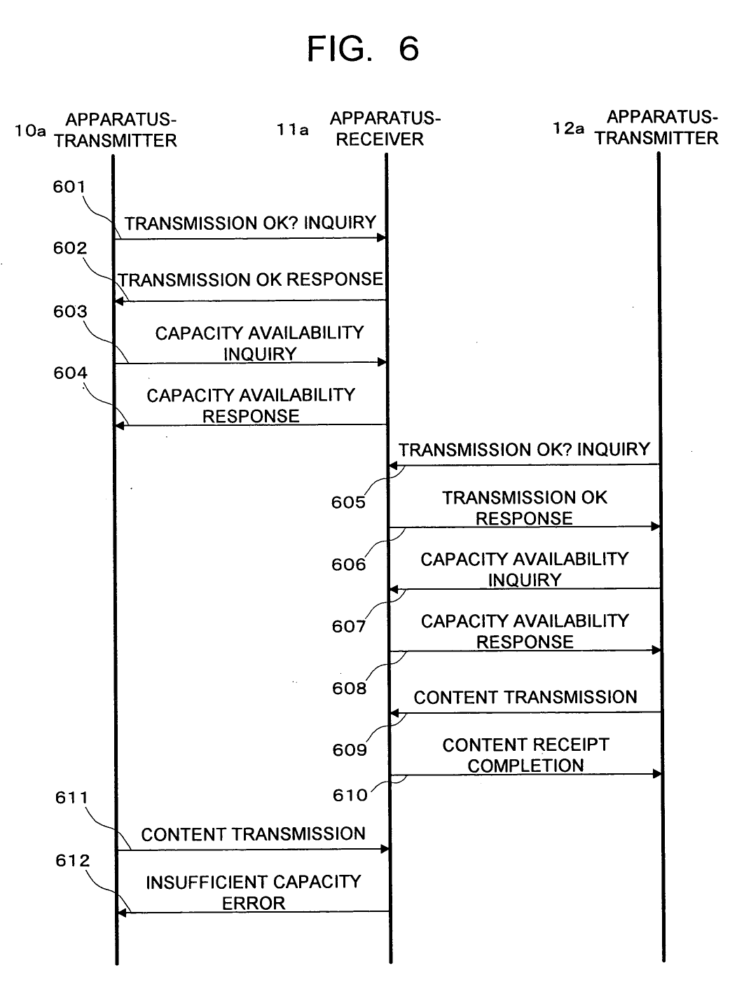

FIG. 6 is a timing chart related to a content transmission in the case where three units of general information recording/reproducing apparatuses are connected via the router or network. Briefly, the entire system here is in a connection state shown in FIG. 5 as an outline, however, the respective information recording/reproducing apparatuses have different configuration from those shown in FIGS. 5, 2, 3 (from the main units 101, 111, 121, in particular), respectively.

As shown in the drawing, first, a transmitter apparatus 10a makes inquiries to a receiver apparatus 11a about whether or not a content transmission is acceptable, and about an available capacity (Steps 601, 603). It is assumed that, just when a response thereto is returned from the receiver apparatus 11a to the transmitter apparatus 10a (Steps 602, 604), a session start request is transmitted to the receiver apparatus 11a from a different transmitter apparatus 12a (step 605). When the request from the different transmitter apparatus 12a is processed first for the convenience of a load on the network, a session is established between the different transmitter apparatus 12a and the receiver apparatus 11a (Steps 605 to 608), and a content transmission processing of the transmitter apparatus 12a is performed first (Step 609).

Specifically, there may be a case where, before the content transmission related to a first session is performed actually from the transmitter apparatus 10a to the receiver apparatus 11a, the transmitter apparatus 12a related to a second session completes a content transmission to the receiver apparatus 11a (Step 610), and with this content transmission, the available disk capacity of the receiver apparatus 11a is consumed to cause a content transmission processing error of the transmitter apparatus 10a (Step 612). Thus, when performing a content transmission processing between the transmitter apparatus 10a and the receiver apparatus 11a, the transmission processing may have an inconvenience due to an interrupt by the other apparatus (here, 12a).

Subsequently, the operations of the information recording/reproducing apparatuses which have a configuration specific to the preset embodiment will be described. As shown in FIG. 5, the video recording/reproducing apparatuses 10, 11, 12 connected to the network have the configuration specific to the present embodiment.

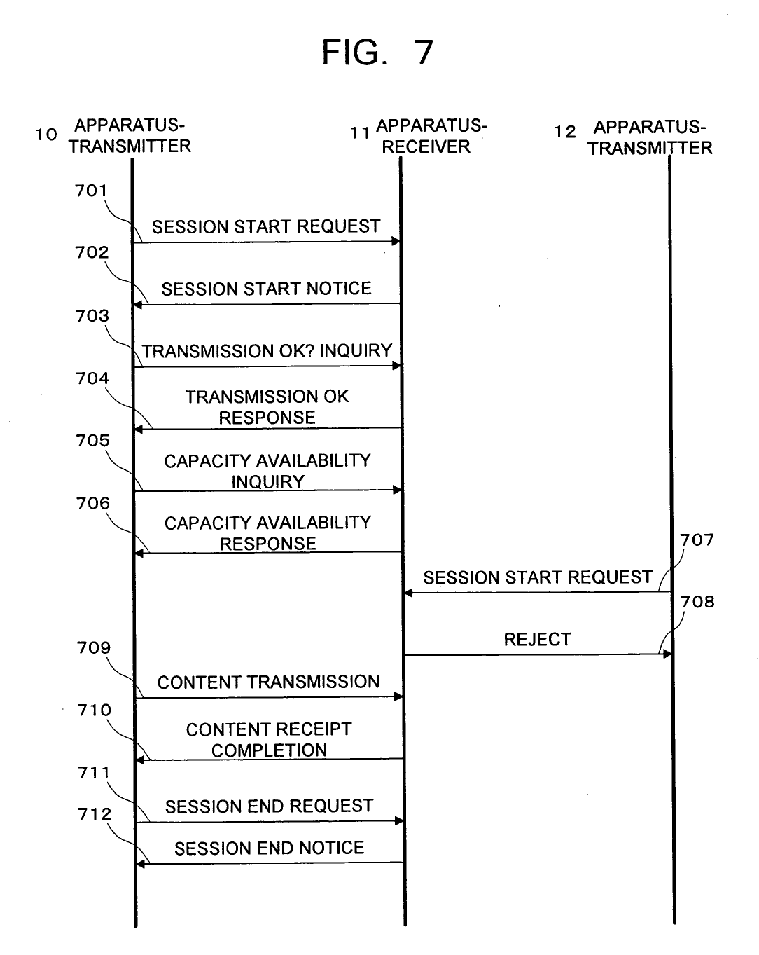

Therefore, as a measure to prevent the above problem, the receiver apparatus 11 is provided with a mode to reject the transmission request from the other apparatus 12, as a configuration specific to the present embodiment. FIG. 7 is a timing chart related to a content transmission in the case where three units of the information recording/reproducing apparatuses according to the embodiment of the present invention are connected via the router or network.

As shown in the drawing, the information transfer response unit 10141 of the transmitter apparatus 10 issues the “session start request” to the receiver apparatus 11 via the communication control unit 107, firstly (Step 701). When receiving this request, the receiver apparatus 11 enters into a mode (other session reject mode) rejecting every other request except that from the transmitter apparatus 10. Specifically, in the step when a (not-shown) information transfer response unit 11141 of the receiver apparatus 11 received the session start request information from the transmitter apparatus 10 via the communication control unit 117, for example, a (not-shown) flag establishment section in a main control unit 11140 makes a busy flag (which may be an other session reject mode flag, the same is applicable hereinafter) ON (Step 702), and at the same time, the information transfer response unit 11141 returns the “session start notice” to the transmitter apparatus 10 (Step 702).

Subsequently, the information transfer response unit 10141 of the transmitter apparatus 10 makes an inquiry about whether or not the transmission is acceptable (Step 703), the (not-shown) information transfer response unit 11141 of the receiver apparatus 11 receiving the inquiry returns the transfer acceptable response (Step 704). The information transfer response unit 10141 of the transmitter apparatus 10 receiving the response transmits the “available capacity inquiry” to the receiver apparatus 11 (Step 705), and the information transfer response unit 11141 of the receiver apparatus 11 receiving the inquiry returns to the transmitter apparatus 10 an “available capacity information” acquired by the (not-shown) main control unit 11140 via a record unit 11144 (Step 706).

At this time, the other session start request is transmitted from the other transmitter apparatus 12 to the receiver apparatus 11 (Step 707). In the receiver apparatus 11 receiving the request, a (not-shown) decision unit 11142 checks the busy flag in a (not-shown) memory (for example, in a temporary memory, the same is applicable hereinabove and hereinafter) and determines to be busy based on the ON flag (Step 708), and returns a reject response to the transmitter apparatus 12 (Step 708). Without regard to such Step 707, occurring or not occurring, the information content transmission unit 10143 of the transmitter apparatus 10 starts the content transmission (Step 709) .

Thus, for example, by making the flag ON when a session is established once, the other session reject mode is established to thereby reject the session start request transmitted from the others when the busy flag in ON, so that the content transmission processing with respect to the transmitter apparatus 10 related to the first session can be continued (Step 709). When the content transmission processing is completed, the (not-shown) information transfer response unit 11141 of the receiver apparatus 11 issues the content receipt completion notice to the transmitter apparatus 10 (Step 710). In the transmitter apparatus 10 receiving the content receipt completion notice, for example, the busy mode release instruction section in the main control unit 11140 generates a busy mode release instruction and the main control unit 11140 issues a session end request to the receiver apparatus 11 (Step 711). The session end request contains an instruction information to end this session, in other words, an instruction information to release the previously-established busy mode, which is a mode rejecting every session request from the other apparatus during a session (other session reject mode). For such an instruction information, for example, an information to release the above-described busy flag may be employed.

The (not-shown) information transfer response unit 11141 of the receiver apparatus 11 receiving the instruction information retunes a session end notice to the transmitter apparatus 10 (Step 712) and, at the same time, the (not-shown) main control unit 11140 of the receiver apparatus 11 clears the busy flag in the (not-shown) memory (Step 712). With this clearing operation of the busy flag (Step 712), the exclusive operation ends here.

The technical spirit according to the present embodiment is applicable to a pull-type transmission in addition to the push-type transmission. The pull-type transmission is a transmission method of a type in which the apparatus requesting a content acquires the content from the transmitter apparatus.

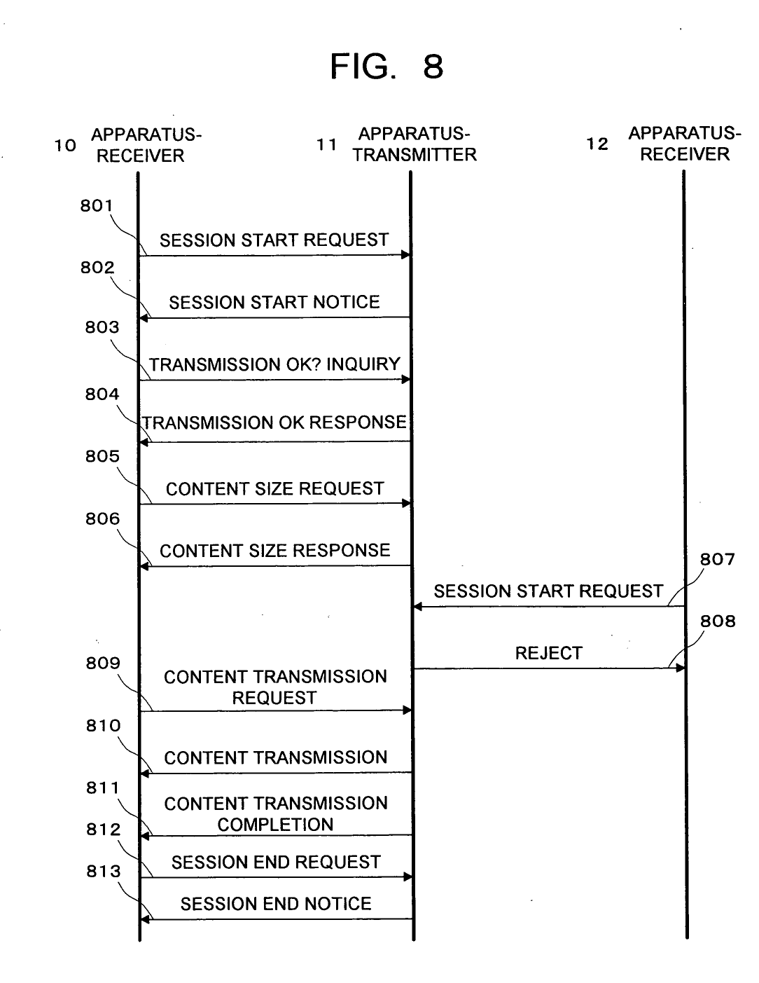

FIG. 8 is a timing chart related to a content transmission in the case where the three units of information recording/reproducing apparatuses of the pull-type according to the present embodiment are connected via the router or network. Hereinafter, the description will be given only of characteristic points in the case of adopting the pull-type transmission for the present embodiment, and for the detail description of the other parts, refer to the corresponding description in the case shown in FIG. 7.

As shown in FIG. 8, in the case of the pull-type transmission, the receiver apparatus 10 requesting for a content transmits the session start request to the transmitter apparatus 11 before the content transmission (Step 801). When the session is established (Step 802), the apparatuses transits to the transmission acceptable/unacceptable inquiry and response (Steps 803 to 804). As a characteristic point of the pull-type transmission, a content size request is issued to the transmitter apparatus 11 (Step 805) instead of issuing the available capacity inquiry (Step 705), to thereby confirm whether or not the content can be stored in the record medium of the receiving apparatus (Step 806); and a content transmission request is issued to the transmitter apparatus 11 (Step 809). The other parts in FIG. 8 other than the above are the same as the corresponding parts in FIG. 7.

That is, when the content transmission request is issued (Step 809), then the content transmission starts (Step 810). When the content transmission is completed (Step 811), then the session ends (Steps 812 to 813). With this configuration, the request transmitted from the other receiver apparatus is rejected completely during a session is established.

It should be noted that, when the network is disconnected in the course of an established session due to a network failure or the like, the disconnected apparatus may become impossible to perform the content transmission unless it is rebooted. It is therefore required during a session to monitor the connection state of the network and to perform a session end processing when the communication is disconnected for a predetermined time period. Specifically, for example, when the main control unit 10140 monitors and detects a case where a network communication with an opposite party with which a session is once established is disconnected for a predetermined time period, then the session is deemed to end and a request from the other apparatus is made acceptable.

In other words, in this case, the main control unit 10140 is provided with a (not-shown) time measurement function, a (not-shown) communication monitor function monitoring a communication state with respect to a holder of the IP address related to a session established or to be established at intervals of a predetermined unit time (for example, every 10 seconds), and a (not-shown) noncommunication session release function releasing the session when detecting a noncommunication of such a session for a predetermined time period. More specifically, first, the time measurement function makes a (not-shown) communication monitor flag ON every 10 seconds, and at the same time transmits a time signal to the communication monitor function. In response to the detection of this time signal, the communication monitor function confirms whether or not a communication exists between a previous time signal and a subsequent time signal (namely, for a time period of 10 seconds before to the current time) and makes the communication monitor flag OFF when the communication is confirmed. This communication monitor flag establishment by the time measurement function→the communication monitor flag initialization by the communication monitor function is repeated at intervals for example of 10 seconds. In this case, when a noncommunication arises, for example, for 10 seconds between the own apparatus and the IP address being the opposite party of the session, the communication monitor function does not make the communication monitor flag OFF. Then, the non communication session release function receiving the signal from the time measurement function every 10 seconds determines the flag state to be a timeout being the noncommunication (namely, the communication is determined to be disconnected due to a somewhat abnormal state), and the previously-mentioned other session reject mode is initialized (namely, the other session reject mode is released). With this configuration, it is possible to prevent an event where the other session reject mode is kept effective even when a communication error arises to there by reject any and all transfer from the other apparatus.

Subsequently, a description will be given of another embodiment according to the present invention. Generally, there are some routers that have an automatic IP address assignment function automatically assigning an IP address to each apparatus in the network. This allows the respective apparatuses to be given an available IP address automatically and to ensure the IP address internally without the need of initialization every time. Meanwhile, there are some routers that have a function changing the IP address one by one at intervals of a predetermined time period. In the case of the router of this type, when the IP address of the opposite party is changed in the course of a session, the session is interrupted.

Accordingly, in this another embodiment, there is further provided a function omitting an IP address change request (command) given, on the video recording/reproducing apparatus side, even when the IP address change request is given during the time period from a session start to the session end.

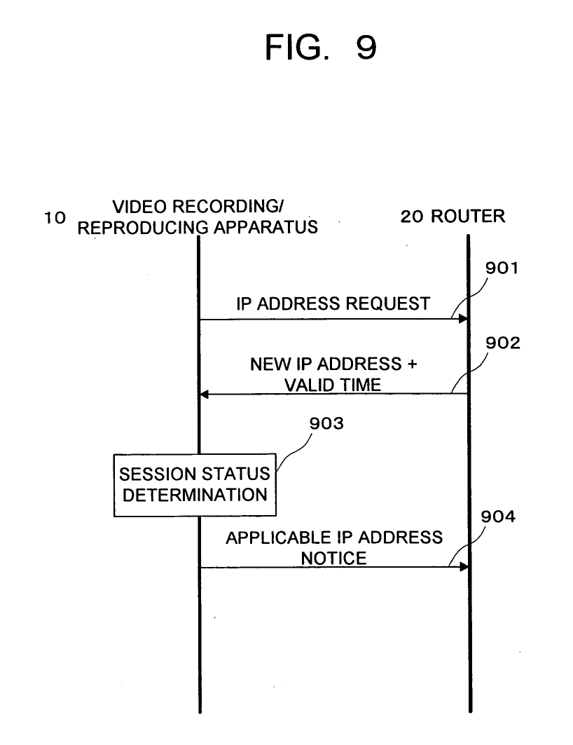

FIG. 9 is a timing chart to illustrate this function, showing an operation of a video recording/reproducing apparatus according to another embodiment of the present invention.

As shown in the drawing, first, the video recording/reproducing apparatus 10 issues an IP address assignment request to the router 20 (Step 901). In response thereto, the router 20 returns an IP address response to the video recording/reproducing apparatus 10 (Step 902). Specifically, the IP address response is, for example, an IP address information and a valid time (seconds) related to the IP address information (Step 902). The steps 901 to 902, namely the IP address request→IP address assignment, are performed repeatedly for each valid time (done so until just before the valid time expires, when more appropriate). Here, generally, when receiving the IP address request from the video recording/reproducing apparatus 10, the router 20 returns the same IP address to the video recording/reproducing apparatus 10 as the IP address originally given thereto, in the case of the video recording/reproducing apparatus originally given the IP address (Step 902), however, there are some routers 20A of a certain type which assign a new IP address different from the previous IP address (Step 902) then.

Therefore, in the video recording/reproducing apparatus 10 according to the present embodiment, the MPU 1014 is provided with a (not-shown) session status decision function recognizing a session establishment status, and a (not-shown) IP address determination function determining the IP address to be notified to the router depending on the decision made by the session status decision function.

More specifically, first, the main control unit 10140 of the MPU 1014 transmits the IP address request via the communication control unit 107 to the (not-shown) router 20A being a DHCP server (Step 901), and the router 20A returns a second IP address different from a first IP address being the previous IP address (Step 902). In the video recording/reproducing apparatus 10 receiving the second IP address, the session status decision function (for example, of the decision unit 10142) makes a decision on whether or not the session is established at that moment (Step 903). Specifically, for example, whether or not the other session reject mode flag is ON is determined, and when the other session reject mode is determined to be ON, it is in the course of the session, in which an IP address change causes an unexpected interruption. Hence, for preventing this, the previous first IP address should be kept effective, and the IP address determination function determines that the IP address to be notified to the router 20A is the first IP address (Step 903).

On the other hand, when the session status decision function (for example, of the decision unit 10142) determines that the other session reject mode flag is OFF, namely, it is not in the other session reject mode state, then, it is not in the session, in which the IP address change causes no problem. Therefore, the IP address determination function determines that the IP address to be notified to the router 20A is the second IP address (Step 903). Next, the main control unit 10140 of the MPU 1014 notifies the IP address thus determined in Step 903 to the router 20A via the communication control unit 107.

As described above, according to the present embodiment, even when the video recording/reproducing apparatus is connected to the router changing the IP address with time, it is configured such that the IP address is continuously kept to be effective during the session established, preventing the once established session from being interrupted by an unexpected IP address change, so that the transfer operation can be continued to the end of the session.

As stated above, according to the embodiment of the present invention, when the video recording/reproducing apparatus having the content recorded in the internal record medium thereof transmits the content to the other video recording/reproducing apparatus, before the content transmission, the transmitter apparatus makes the busy flag ON to let the receiver apparatus reject every content transmission request from the other apparatus, the receiver apparatus being separated thereafter by the flag. With this, when performing a content transmission between the first transmitter apparatus and receiver apparatus, no such a case is caused that the content transmission is interrupted by the request from the second apparatus to allow the content transmission from the second transmitter apparatus to occur. Accordingly, it is possible to prevent an inconvenience of transmission processing in which an insufficient capacity error is caused by consuming the available disk capacity intended for the content transmission of the first transmitter apparatus due to the above-described interrupt by the second transmitter apparatus, the inconvenience possibly occurring in the network having many apparatus connected thereto.

Further, after the end of the content transfer processing, the command to reset the mode to accept the content transmission request from the other apparatus is issued, so that the event, in which the network is disconnected due to a network failure or the like in the course of the session and the apparatus becomes unable to perform the content transmission unless the apparatus is rebooted, can be prevented.

Still further, according to the present embodiment, when a client apparatus performs an acquisition of a content data from the video recording/reproducing apparatus recording the content in the internal record medium thereof, before the content transmission request, it is possible to transmit a mode change command to change the mode of the video recording/reproducing apparatus having the content to reject every content transmission request from the other apparatus. Accordingly, even in the case of the so-called pull-type transmission, when performing a content transmission between the first transmitter apparatus and receiver apparatus, it is possible to prevent the interrupt by the request of the second transmitter apparatus and the content transmission from the second transmitter apparatus from occurring. Hence, the inconvenience of transmission processing possible to be caused in the network having many apparatuses connected thereto, such that the available disk capacity intended to be used for the transmission of the first transmitter apparatus is consumed to cause an insufficient capacity error for the transmission processing of the first transmitter apparatus, can be prevented.

Still further, according to the embodiment of the present invention, it is configured such that the timeout is provided in the mode of the above-described embodiment, so that, when no network communication is performed with the opposite party with which the session is established for a predetermined time period, the session is deemed to end, and the apparatus is enabled to accept the request from the other apparatus.

According to the embodiment of the present invention, a further convenient and usable information recording/reproducing system and information recording/reproducing apparatus can be provided for users by providing the network-based information recording/reproducing system and information recording/reproducing apparatus.

As mentioned before, the embodiments of the present invention can be recognized as a network-based information recording/reproducing system and also an information recording/reproducing apparatus.

It should be noted that the present invention is not limited to the above-described respective embodiments and the present invention allows various modification within the scope of the technical spirit of the present invention.

In the above-described embodiments, a method, in which, when the video recording/reproducing apparatus having a content recorded in the internal record medium thereof transmits the content to the other video information recording/reproducing apparatus via the network, in order for the transmitter apparatus to realize the mode change of the receiver apparatus to reject every content transmission request from the other apparatus, before the content transmission, the busy flag is made ON at the stage that the main control unit receives the session start request, has been described. Notwithstanding the above, the technical spirit of the present invention is not limited to the method, and, for example, when the video recording/reproducing apparatus having a content recorded in the internal record medium thereof transmits the content to the other video recording/reproducing apparatus via the network, before the content transmission, the transmitter apparatus may transmit an instruction to the receiver apparatus to let the receiver apparatus change the mode to reject every content transmission request from the other apparatus. Therefore, when performing a content transmission processing between the first transmitter apparatus and receiver apparatus, the method may be the one preventing the content transmission from the second transmitter apparatus caused by the interrupt from occurring in the above-described manner. Moreover, in addition to the above, the technical spirit according to the present invention is applicable to every technology capable of realizing the rejection of every other request in the busy state.

Furthermore, the present invention allows various modification, addition, replacement, expansion, reduction, and so forth within the same and equivalent scope as/to the technical spirit of the present invention. Further, even when an apparatus, method, software, or system that is produced using the present invention is commercialized by being mounted in a secondary product, the fact in no case reduces the value of the present invention.

It is understood that the present invention is not limited to specific embodiments described herein with reference to the drawings, and that modifications included in the scope of the claims described hereinafter are all within the scope of the present invention.

What is claimed is:

1. A network-based information recording/reproducing system having a plurality of information recording/reproducing apparatuses connected via a network/router to transmit/receive information including video among the information recording/reproducing apparatuses, each of the information recording/reproducing apparatus is provided with at least a processing unit, a first and/or second information medium device(s), and a communication control unit, the system comprising:
a first information recording/reproducing apparatus being a transmitter or requester of information that transmits a session start request to a second information recording/reproducing apparatus connected thereto via the router/network, receives a session establishment notice being a return to the session start request, transmits an information content to the second information recording/reproducing apparatus, receives a content receipt completion notice from the second information recording/reproducing apparatus, and transmits an instruction to release an other session reject mode to the second information recording/reproducing apparatus; and
the second information recording/reproducing apparatus that notices a session establishment to the first information recording/reproducing apparatus in response to the session start request received and at a same time establishes the other session reject mode rejecting the session start request from a third information recording/reproducing apparatus, and transmits the content receipt completion notice to the first information recording/reproducing apparatus when the information content transmitted by the first information recording/reproducing apparatus is completely received.

2. A network-based information recording/reproducing system as set forth in claim 1,
wherein the second information recording/reproducing apparatus is set a timeout releasing the other session reject mode established when detecting no communication for a predetermined time period.

3. A network-based information recording/reproducing system as set forth in claim 1,
wherein the second information recording/reproducing apparatus uses a flag to establish/release the other session reject mode.

4. A network-based information recording/reproducing system as set forth in claim 1,
wherein the second information recording/reproducing apparatus makes an inquiry, at predetermined time intervals, to the router about a new IP address that the second information recording/reproducing apparatus should have in a next time period, when the other session reject mode is established; and receives the new IP address when the new IP address is returned in response to the inquiry, and
wherein the second information recording/reproducing apparatus continuously have a previous IP address during the other session reject mode is established as the IP address of the second information recording/reproducing apparatus itself even when the new IP address is different from the previous IP address.

5. An information recording/reproducing apparatus provided with at least a central processing unit, a first and/or second information medium device(s), and a communication control unit, the central processing unit comprising:
an information transfer response means for transmitting via the communication control unit a session start request for an information content transmission to opposite information recording/reproducing apparatus(es) connected thereto via a router/network, returning a session establishment notice to an opposite information recording/reproducing apparatus in response to the session start request received, and transmitting a transfer completion notice to the opposite information recording/reproducing apparatus when an information transfer is completed;
a control means for establishing an other session reject mode when receiving the session start request, the other session reject mode rejecting session start request(s) from other information recording/reproducing apparatus(es) than the information recording/reproducing apparatus being a requester of the session start request once received, the control means being also capable of releasing the other session reject mode;
a content transmission means for transmitting an information content to a destination information recording/reproducing apparatus specified by information contained in the session start request;
a record means for recording the transmitted information content onto a first or second information medium; and
a reject mode release instruction means for transmitting an instruction signal to release the other session reject mode to an opposite apparatus when receiving the transfer completion notice notifying of a completion of an information content transfer.

6. A information recording/reproducing apparatus as set forth in claim 5,
wherein the control means have a timeout function releasing the other session reject mode established when no communication is detected for a predetermined time period.

7. A information recording/reproducing apparatus as set forth in claim 5,
wherein the control means uses a flag to establish and release the other session reject mode.

8. A information recording/reproducing apparatus as set forth in claim 5,
wherein the control means includes a means for making an inquiry to the router at predetermined intervals when the other session reject mode is established about an new IP address that the information recording/reproducing apparatus should have in a next time period; and a means for continuously having a previous IP address as an IP address of the information recording/reproducing apparatus itself during the other session reject mode is established even when the new IP address is different from the previous IP address.
